(19) United States
(12) Patent Application Publication
(10) Pub. No.: US 2014/0150249 A1
(43) Pub. Date: Jun. 5, 2014

(54) COLD ROLLED MOTOR LAMINATION ELECTRICAL STEELS WITH REDUCED AGING AND IMPROVED ELECTRICAL PROPERTIES

(71) Applicant: Gwynne Johnston, Barrington Hills, IL (US)

(72) Inventor: Gwynne Johnston, Barrington Hills, IL (US)

(21) Appl. No.: 13/692,013

(22) Filed: Dec. 3, 2012

(51) Int. Cl. H01F 41/02; C22C 38/02; C22C 38/04; C22C 38/06; C22C 38/34; C22C 38/16; C22C 38/08; C22C 38/12; C22C 38/18; C22C 38/00; C22C 38/60

(52) U.S. Cl. CPC H01F 41/0206; C22C 38/008; C22C 38/02; C22C 38/004; C22C 38/04; C22C 38/06; C22C 38/60; C22C 38/16; C22C 38/08; C22C 38/12; C22C 38/18; C22C 38/34
USPC 29/602.1; 420/87; 420/103; 420/117; 420/8; 420/89; 420/119; 420/104; 420/123

(57) ABSTRACT

A semi-processed electrical steel is provided comprising the elements

| | | |
|---|---|---|
| .005 ≦ | Tin ≦ | .09% |
| 0 < | Carbon ≦ | 0.050% |
| .10 ≦ | Manganese ≦ | 1.00% |
| .005 ≦ | Phosphorus ≦ | .120% |
| .0 < | Sulfur ≦ | .010% |
| .50 ≦ | Silicon ≦ | 2.50% |
| .01 ≦ | Aluminum ≦ | 1.60% |
| .0 ≦ | Antimony < | .02% |

Iron—at least substantial portion of balance

### BACKGROUND

### Introduction

Cold Rolled Motor Lamination (CRML) electrical steels, which are understood herein to include electrical steels for applications in motors, transformers, alternators, generators, ballasts, or other electrical products, have been developed and used in the USA predominantly for more than 50 years. This type of steel was initially an improvement of commercial quality steels through the addition of small amounts of silicon and annealing of the products after stamping. The growth of this electrical steel in the USA during the 1970's and 1980's was driven by the relative low cost of production within integrated steel mills which used the same equipment to produce CRML electrical steel as was used to produce high volume automotive and commercial quality cold rolled steel. The incentive for the steel mills was that CRML steel provided a premium to conventional cold rolled steel, had very high productivity rates, and very few of the rejections or quality issues associated with automotive sheet steel. In the United States, CRML electrical steel is known as semi-processed because it requires annealing after stamping. In other countries, the development of electrical steel has been focused on fully processed electrical steel which can be used in the as-stamped condition without further annealing. This has also been influenced by the higher costs of energy in other countries, which has an effect on the commercial benefits of annealing.

For the purposes of definition for this patent application, CRML electrical steel is characterized as flat rolled steel used for electrical applications (motors, generators, alternators, transformers, ballasts, or other products using cores) where the final steps at the steel mill are annealing (either box or continuous anneal), and followed by a temper rolling (sometimes called skin passing) in which the extension or elongation exceeds 2%. As a result, CRML steels require a further anneal after stamping in order to develop full magnetic properties. By contrast, fully processed steel has annealing, either box or continuous anneal, and does not involve a further temper rolling step. At the completion of the anneal at the steel mill, fully processed steel has developed the final properties desired for the electrical application.

CRML electrical steel is also known as semi-processed electrical steel because it requires the additional process of annealing in order to produce satisfactory magnetic properties. Annealing of CRML electrical steels, after stamping, requires a very controlled balance of temperature, time at temperature and a decarburizing atmosphere that permits selective removal of carbon from the steel but does not allow oxidation of the steel. The removal of carbon is controlled by diffusion of the carbon from the body of the steel to the surface where it reacts with a controlled partial pressure of oxygen to form carbon monoxide. Control of temperature and time at temperature allows for the diffusion and reaction to take place. The thermodynamics and stability of the appropriate partial pressure of oxygen to achieve decarburization without oxidation of steel are relatively well understood. There are, however, processes that are used to control the partial pressure of oxygen in addition to various furnace designs which can be combined to provide differing qualities of anneal, even for the same grade of steel.

From the above and an understanding of metallurgical thermochemistry, one can conclude that:
the initial or starting level of carbon in the steel will have a big effect on both the time for decarburization as well as the final carbon concentration, and
the addition of alloying elements such as silicon and aluminum, which slow down diffusion of carbon within steel, will have an effect on both the time and the temperature required for diffusion.

As a result, the strategy for development of CRML electrical steels has been to focus on the supply of ultra-low carbon levels, typically <0.010% carbon, which may be achieved by vacuum degassing of the steel in the liquid state, prior to continuous casting.

All element percentages expressed in this specification are weight percent.

In the late 1980's and early 1990's, another strategy was developed (Lyudkovsky et al, Inland Steel, and others in different countries) whereby a further small addition of antimony was made to the CRML steel. The function of the antimony was to block any oxidation of the base steel but still allow diffusion of carbon for reaction and removal. In this form, antimony was considered to be a surface inhibitor to steel. The addition of antimony was particularly effective for CRML grades with higher carbon levels (0.02 to 0.04% carbon) and, as a result, is now used as standard practice in most grades of CRML steels. This includes higher grades of CRML with increased levels of silicon, which require higher annealing temperatures and are, as a result, more prone to oxidation.

One of the other characteristics of electrical steel, both fully processed and semi-processed, is a phenomenon known as aging, whereby core loss will increase over a period of time, usually as a result of elevated temperatures associated with the operating temperature of the motor or transformer. Aging in electrical steels has been relatively well researched and is known to be the result of sub-micron diffusion of carbon (and in some cases nitrogen) to form clusters or zones. These clusters or zones are similar to Guinier-Preston zones well known in aluminum alloys. They are not precipitates but do result in lattice strain which causes an increase in core loss. Conventional Industry knowledge and experience indicates that electrical steels should be less than 0.005% carbon and preferably less than 0.003% carbon for higher grades in order to minimize the effects of aging (which cannot be totally eliminated).

Low grades of CRML steels do not show significant aging if they have been properly annealed with carbon less than 0.003%. High grades of fully processed electrical steel with silicon contents above 2.0% also do not show significant aging when the carbon content is <0.003%. In this case, the higher levels of silicon limit or restrict the diffusivity of carbon, providing a restriction to the formation of carbon zones or clusters. Higher grades of CRML steels have silicon contents between 0.50% and 2.5% and, as a result, can show significant aging.

It should be noted that the process of annealing of higher grades of fully processed electrical steel at the steel mill normally involves an additional decarburization step to further reduce the carbon content from incoming levels of <0.005% as supplied during steel making.

### SUMMARY

It is an object to provide a semi-processed electrical steel with reduced aging and providing improved magnetic properties.

A semi-processed electrical steel is provided comprising

| | | |
|---|---|---|
| .005 ≦ | Tin ≦ | .09% |
| .0 < | Carbon ≦ | 0.050% |
| .10 ≦ | Manganese ≦ | 1.00% |
| .005 ≦ | Phosphorus ≦ | .120% |
| .0 < | Sulfur ≦ | .010% |
| .50 ≦ | Silicon ≦ | 2.50% |
| .01 ≦ | Aluminum ≦ | 1.60% |
| .0 ≦ | Antimony < | .02% |

Iron—at least substantial portion of balance

### BRIEF DESCRIPTION OF THE DRAWINGS

FIG. 1 illustrates in Table 1 core loss data for aging of various grades of conventional CRMO electrical steel grades;

FIG. 2 shows in Table 2 core loss data for aging of fully processed electrical steel grades with a wide range of silicon contents;

FIG. 3 shows in Table 3 core loss data for aging of various grades of electrical steel subjected to sequential annealing in a decarburizing atmosphere followed by an accelerated aging;

FIG. 4 shows in Table 4 core loss data for aging of various grades of electrical steel (after combined anneal and aging) in Table 3 together with measured carbon values after each of successive decarburizing annealing steps, and also compares to antimony values for the different grades;

FIG. 5 shows for preferred exemplary embodiments of the present invention at least some of the constituents of the electrical steel and including tin as an alloying element but with antimony substantially or totally removed as an alloying element; and

FIG. 6 shows a process for manufacturing an improved electrical core using improved semi-processed electrical steel.

### DESCRIPTION OF EXEMPLARY PREFERRED EMBODIMENTS

For the purposes of promoting an understanding of the principles of the invention, reference will now be made to the preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included. All element percents set forth herein are weight percents.

Examples of Aging for Different Grades of Electrical Steel

As it implies, aging in electrical steel is a measurement of deterioration of magnetic properties, specifically core loss, over an extended period of time. However, in order to develop meaningful data which can assist in predicting the extent of aging it is usual for accelerated tests to be used where samples can be subjected to slightly elevated temperatures for relatively short periods of time. One frequently used set of test conditions uses 200° C. for 24 hours as the conditions to develop accelerated aging. The agreed standard in industry is that the increase in core loss in an electrical steel grade, following exposure to accelerated aging conditions of the type described above, should be <10% of the initial or starting value prior to aging. Other accelerated aging tests may be used and the conclusions will be similar.

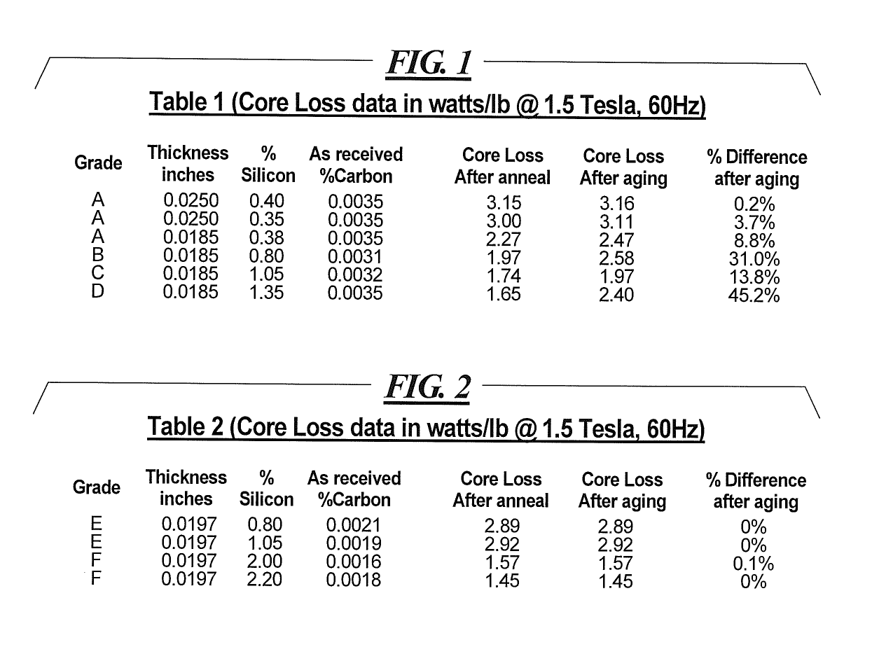

During the development of the preferred exemplary embodiments of the invention described hereafter, a number of grades of semi-processed and fully processed electrical steels, with different silicon contents, were subjected to accelerated aging conditions. It should be noted, as previously described above, that semi-processed steel grades receive an additional decarburizing anneal after stamping of steel laminations, whereas fully processed grades receive their final anneal at the steel mill prior to stamping. There is one other significant difference between semi-processed and fully processed electrical steel grades. Fully processed steel grades usually possess a surface coating on both sides of the steel strip, whereas semi-processed grades do not have a coating and rely on the presence of antimony and control of the oxygen partial pressure during annealing to protect the steel from oxidation, while at the same time permitting decarburization to take place. Table 1 in FIG. 1 shows the results of these tests.

The results in Table 1 of FIG. 1 illustrate several concepts about aging in conventional CRML electrical steel grades:
The % aging, or the difference in % between the initial core loss and the core loss measured after accelerated aging, increases as the amount of silicon increases.
The results show considerable scatter but, in general, % aging in conventional CRML electrical steel grades is less than 10% when silicon is less than 0.50% and the level of as-received carbon is less than 0.005%.
Conventional CRML electrical steel grades with % silicon contents above 0.50% can show significant aging, which exceeds 10%, and the amount of aging increases as the amount of silicon and carbon increases.

By contrast, in the development of the inventive preferred exemplary embodiments described hereafter, similar aging tests were completed for fully processed electrical steel grades with a much wider range of silicon contents. These samples were also annealed in a decarburizing atmosphere so that they experienced exactly the same processing as the semi-processed samples. The results are shown in Table 2 of FIG. 2.

The results in Table 2 of FIG. 2 show that, even with elevated levels of silicon, there is almost no aging with these grades of steel after exposure to accelerated aging test conditions. It is noted, however, that the average carbon contents are lower than for the same group of semi-processed grades examined in Table 1.

To learn and understand more about the mechanics of aging, and, specifically about the contribution of residual carbon on aging, further tests were completed as part of the development of the preferred exemplary embodiments herein where the same samples, shown in Table 1, were progressively subjected to sequential annealing in a decarburizing atmosphere followed, in each case, by accelerated aging. Conventional theory would suggest that progressive exposure to a series of annealing cycles in a decarburizing atmosphere would have the effect of progressively removing carbon and, as a result, progressively reduce % aging. The results are shown in Table 3 of FIG. 3.

The results in Table 3 of FIG. 3 provide several insights into the mechanics of aging for different grades of electrical steel, as follows:
Aging does not typically occur in CRML electrical steel grades after decarburizing anneal when the silicon content is below 0.50%.
The effects of aging for conventional CRML electrical steel grades, where the silicon content is above 0.50%, are reversible as a result of a subsequent full anneal. This indicates that the carbon clusters, formed during aging, do not form precipitates and re-distribute into the matrix as a result of a subsequent anneal.
The effects of aging for conventional CRML electrical steel grades decrease with subsequent anneals, but do so at a much slower rate for electrical steel grades with higher silicon levels.

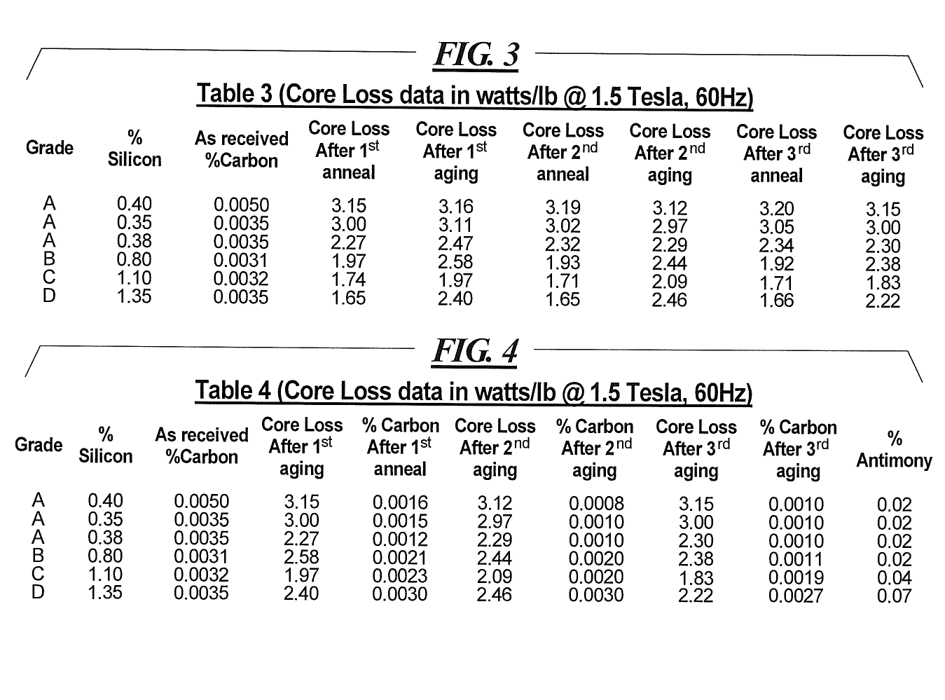

The results in Table 3 of FIG. 3 can be more readily interpreted by comparing the core loss values (after combined anneal and aging) in Table 3 with measured carbon values after each of the successive decarburizing annealing steps, and to the antimony values for the different grades. This data is shown in Table 4 of FIG. 4.

The results from Table 4 of FIG. 4 clearly show that
Significant aging occurs in conventional CRML electrical steel grades with silicon equal to or above 0.50% after a decarburization anneal when the residual carbon exceeds 0.0020%.
The proportional effect of aging increases as the amount of residual carbon exceeds 0.0020%.
The amount of silicon above 0.50% has an effect on the amount of carbon removed during decarburization but there also appears to be an effect or contribution from the amount of antimony in the CRML electrical steel grade.

U.S. Pat. Nos. 4,421,574 and 4,483,723 from Lyudkovsky et al., teach that the function of antimony is to prevent internal oxidation of the steel during decarburization anneal. Should internal oxidation occur, even at the surface of the steel, magnetic properties of the steel are degraded; specifically, core loss increases. Electrical steel is especially sensitive to internal oxidation because of the high affinity (free energy of formation) between oxygen and silicon.

The Alternative: CRML Grades with Reduced Aging and Improved Magnetic Properties

The data in Table 2 of FIG. 2 shows that fully processed electrical grades of steel, even with higher levels of silicon than is found in conventional CRML grades, may be fully decarburized to levels below 0.0020% carbon and therefore show no measureable aging characteristics. The most important issue, which is referenced in Table 4 of FIG. 4, is that, since conventional semi-processed grades contain levels of antimony varying from 0.02% to 0.07%, fully processed electrical steel grades do not contain antimony as a defined addition. It therefore has been discovered that the beneficial aspects of antimony, which blocks oxygen from entering the steel to potentially cause internal oxidation during decarburization annealing, also has the same blocking effect in preventing carbon from exiting the steel to react with oxygen (the fundamental process of decarburization).

If antimony is removed from conventional CRML semi-processed electrical steel grades, the following occurs. For grades with % silicon <0.50%, there is no change in magnetic properties as a result of the decarburization anneal and the steel may be fully decarburized to show only minor effects of aging. For steel grades with % silicon >0.50%, the results of a decarburization anneal are an increase in the level of oxidation, which increases as the amount of silicon increases. While the level of decarburization increases without the presence of antimony, the level of internal oxidation also increases, significantly degrading the magnetic properties of the steel, specifically causing an increase in core loss and a decrease in permeability.

The same effect of oxidation, during a decarburization anneal, is not seen in fully processed electrical steel grades, even though these grades have elevated levels of silicon and do not contain antimony. The reason is that the majority of fully processed electrical steel grades have an inorganic coating which forms a ceramic during annealing, thereby reducing or eliminating oxidation of the steel. The process sequence for semi-processed CRML electrical steel involves temper rolling after batch annealing at the steel plant. This does not allow a coating to be applied economically to semi-processed electrical steel grades. So another approach was sought which allows decarburization but prevents or inhibits oxidation of the steel.

It is known in certain sectors of the fully processed electrical steel industry that the addition of tin (Sn) can have a beneficial effect on texture during hot rolling and, as a result, can improve magnetic properties, specifically permeability (which is directly related to texture). Additions of tin are made to specific grades of electrical steel produced by AK Steel in the USA and by other select companies involved in the production of fully processed electrical steel. By circumstance, knowledge of basic metallurgical thermodynamics clearly shows that tin has a strong affinity for oxygen but an aversion for reaction or solubility with carbon.

In the preferred exemplary embodiments of the present invention, for the production of improved semi-processed CRML electrical steel grades, specifically grades with silicon contents ≧0.50% (considered to be what are known as high grade CRML/semi-processed electrical steels), which demonstrate good magnetic properties and reduced levels of aging, the following is provided for:
Antimony is substantially or totally removed as an alloying element; and
Tin is added as an alloying element in amounts varying from greater than or equal to 0.005% to less than or equal to 0.09%.

Substantially or totally removing antimony means the following. Antimony has a weight percent less than 0.02%. However, it is preferable that antimony is less than 0.01%. It is even more preferable to totally remove the antimony. It is further observed that trace antimony such as ≧0.005% may be present as a result of contamination in scrap addition used to manufacture the steel grade.

Tin has a weight percent less than or equal to 0.09% since:
1) it has a beneficial effect on texture; 2) it does not stop or block carbon removal in the way that antimony does; and 3) values above 0.09% result in brittleness in semi-processed/CRML electrical steel. The weight percent for tin is greater than or equal to 0.005%, since that is considered the threshold or measurement limit for residuals levels of tin above which a specific addition of tin has to be made to identify a benefit from the addition.

The following is also noted. For fully processed electrical steel it is known the addition of tin exceeding 0.09% can result in brittleness, the extent and onset of which is dependent on the associated levels of phosphorus, sulfur and, to a lesser extent, the % silicon. This brittleness characteristic, with fully processed electrical steel, dictates an upper practical limit for the addition of tin to CRML electrical steel grades.

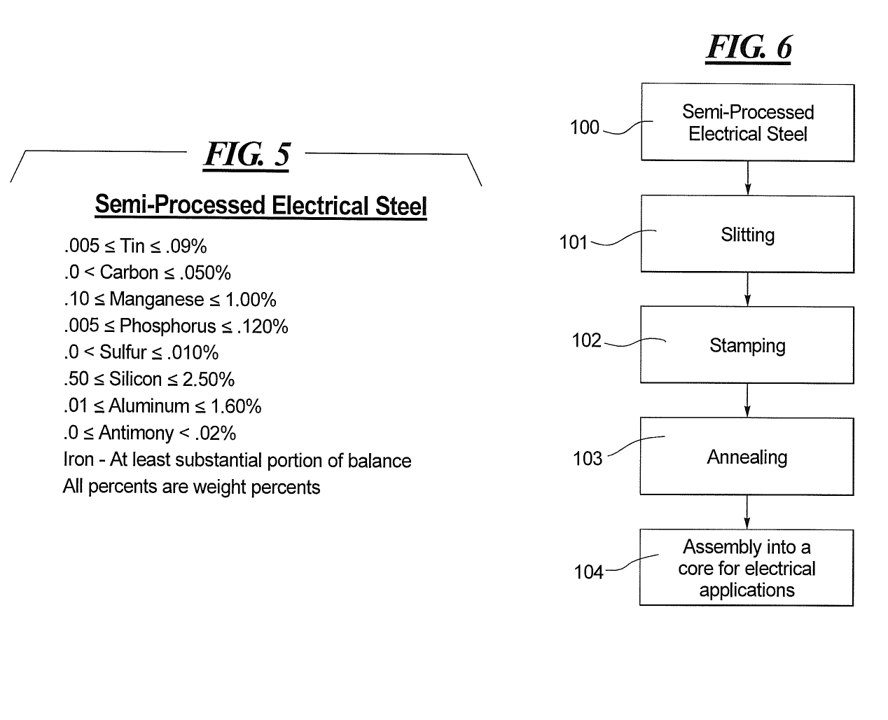

The elimination of antimony and the addition of tin to semi-processed CRML electrical steel grades with typical chemical compositions of significant elements is exemplified in the preferred exemplary embodiments as shown in FIG. 5. Other elements such as copper, nickel, chromium, molybdenum etc. may be present in CRML grades of electrical steel as residual elements, but are not considered significant elements in terms of magnetic properties. The above described CRML grades of electrical steel have the following advantages:
1. A reduction or elimination of aging.
2. Development of good magnetic properties, which are dependent upon the grade (amount of silicon present). Specifically, the same or lower core loss is achieved compared to a conventional CRML electrical steel which contains antimony, examples of which are shown in Table 1, and an improvement in the permeability is achieved.

The above improved semi-processed electrical steel is employed for manufacture of an electrical core having improved magnetic and electrical properties and with reduced aging. As shown in FIG. 6, in step 100 the improved semi-processed electrical steel is provided, is slit to width in step 101, is stamped in step 102, and is annealed after stamping in step 103 followed by assembly of a core in step 104. The stamped parts in loose form may be annealed prior to assembly into a core. Alternatively, the parts may be first assembled into a core as part of stamping and then annealed (by use of a stamping and stacking die).

Thus the process allows for the production of loose laminations, which may be assembled into a core, as well as the direct production of cores during stamping.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

I claim as my invention:

1. A semi-processed cold rolled lamination electrical steel, comprising:

| | | |
|---|---|---|
| .005 ≦ | Tin ≦ | .09% |
| .0 < | Carbon ≦ | 0.050% |
| .10 ≦ | Manganese ≦ | 1.00% |
| .005 ≦ | Phosphorus ≦ | .120% |
| .0 < | Sulfur ≦ | .010% |
| .50 ≦ | Silicon ≦ | 2.50% |
| .01 ≦ | Aluminum ≦ | 1.60% |
| .0 ≦ | Antimony < | .02% |

Iron—at least substantial portion of balance

2. The semi-processed electrical steel of claim 1 wherein antimony is <0.01%.

3. The semi-processed electrical steel of claim 1 wherein antimony is <0.005%.

4. The semi-processed electrical steel of claim 1 wherein antimony is 0%.

5. The semi-processed electrical steel of claim 1 further comprising at least one of the elements selected from the group consisting of copper, nickel, chromium, and molybdenum.

6. The semi-processed electrical steel of claim 1 wherein said semi-processed electrical steel requires an annealing after stamping.

7. The semi-processed electrical steel of claim 1 wherein the carbon is in a range from 0.005 to 0.050%.

8. A method for producing a magnetic core, comprising the steps of:
providing a semi-processed cold rolled electrical steel comprising

| | | |
|---|---|---|
| .005 ≦ | Tin ≦ | .09% |
| .0 < | Carbon ≦ | 0.050% |
| .10 ≦ | Manganese ≦ | 1.00% |
| .005 ≦ | Phosphorus ≦ | .120% |
| .0 < | Sulfur ≦ | .010% |
| .50 ≦ | Silicon ≦ | 2.50% |
| .01 ≦ | Aluminum ≦ | 1.60% |
| .0 ≦ | Antimony < | .02% |

Iron—at least substantial portion of balance;
stamping the semi-processed electrical steel to create stamped parts; and
assembling and annealing the stamped parts after the stamping to form the magnetic core.

9. The method of claim 8 wherein at least one of the elements selected from the group consisting of copper, nickel, chromium, and molybdenum is additionally present in the electrical steel.

10. The method of claim 8 wherein the stamped parts are annealed before the parts are assembled to form the core.

11. The method of claim 9 wherein the stamped parts are annealed after the stamped parts are assembled to form the core.
